(19) United States
(12) Patent Application Publication
(10) Pub. No.: US 2025/0369469 A1
(43) Pub. Date: Dec. 4, 2025

(54) TUBE CONNECTOR

(71) Applicant: Exemplis LLC, Cypress, CA (US)

(72) Inventors: Naxin LIANG, Guangzhou (CN); Huashan YU, Guangzhou (CN); Tao HE, Guangzhou (CN); Futao LIN, Guangzhou (CN)

(21) Appl. No.: 19/247,748

(22) Filed: Jun. 24, 2025

(30) Foreign Application Priority Data
May 29, 2024 (CN) 202421201041.2

(51) Int. Cl. F16B 7/04

(52) U.S. Cl. CPC F16B 7/0413

(57) ABSTRACT

A tube connector can engage the inner wall of tube ends to connect to tube ends together. The tube connector can include a connection block having a guide slot and a secondary part that is slidable in the guide slot. A screw can be used to move the secondary part outwardly for engaging with inner surfaces of the tube ends.

### BACKGROUND OF THE INVENTIONS

### Cross-Reference to Related Applications

The present application claims priority to Chinese Utility Model application No. 202421201041.2 filed May 29, 2024, now Chinese Utility Model Patent No. 22,241,6481U. Additionally, any and all applications for which a foreign or domestic priority claim is identified in the Application Data Sheet as filed with the present application are hereby incorporated by reference and made a part of the present disclosure.

### FIELD OF THE INVENTIONS

The present inventions relates to tubing connection systems, for example, including tubing systems connecting two ends of tubing together.

### DESCRIPTION OF THE RELATED ART

Connection devices are often used to join two independent pieces of tubing together. For example, Chinese patent number CN202222317684 discloses a glass reinforcement tube with a butt style end. The butt feature has an angled section profile which, at the outermost point is towards the open pipe end and at the innermost point is away from the open pipe end. The butt style end feature off both tubes is pressed together while an external clamp utilizes the angled butt feature to press the tubes together and create a seal.

### SUMMARY OF THE INVENTIONS

At least one of the inventions disclosed herein includes the realization that it is advantageous to be able to connect the pieces of tubing together without modifying the tubing ends. This allows for the tube to be cut to length and joined together without the need for an additional step or specific tooling to prepare the ends for joining. Further, certain additional efficiencies can be obtained in connecting two separate pieces of circular tubing together by utilizing a radial force to clamp against the internal diameter of the tubing while eliminating the need for a specific feature in the end of the tube.

Previous iterations of connecting circular tubing together utilize external clamping to create the sealing force between the tubing. This type of method also requires the end of the tubing have a specific end shape, such as a butt or flange, which allows the clamp to force the two ends together to create the seal. This type of connection also requires that the tubing be made of material that has enough strength to withstand the compressive forces of the clamp. Such materials may be fiberglass reinforced plastic (also known as glass fiber reinforced plastic) in nature due to their ability to resist the compressive forces.

Some embodiments disclosed herein, are different from the clamping style connection in CN202222317684 as they do not require any specific end shape for joining or sealing. The material of the tubing is not subject to high compression clamping forces. Forces applied by some embodiments of the connecting portion work outwardly in a radial manner which loads the tubing in tension as opposed to the external clamping method which puts the tubing in a compression manner.

### BRIEF DESCRIPTION OF THE DRAWINGS

These and other features of the inventions disclosed herein are described below with reference to the drawings of several embodiments of the present tubing connection which are intended to illustrate, but not to limit, the inventions. The drawings contain the following figures:

FIG. 1 is a perspective view of the tubing connector in the assembled state prior to insertion into the ends of the tubes.

FIG. 2 is an exploded perspective view of the tubing connector.

FIG. 3 is a cross-sectional view of the tubing connector when it is oriented perpendicular to the axial length of the tubing for which it is inserted, taken along line 3.-3. of FIG. 4.

FIG. 4 is a cross-sectional view of the tubing connector joining two pieces of tubing. The orientation of the view is parallel to the axial lengths of the tubing for which it is joining.

### DETAILED DESCRIPTION OF THE PREFERRED EMBODIMENTS

Embodiments of improved tubing connection are disclosed herein. The packaging systems include various combinations of one or more improved structures which can provide new alternatives to and advantages over known packaging systems.

In the following detailed description, terms of orientation such as “top,” “bottom,” “front,” “upper,” “lower,” “longitudinal,” “horizontal,” “vertical,” “lateral,” “midpoint,” and “end” may be used here to simplify the description in the context of the illustrated embodiments. Because other orientations are possible, however, the present inventions should not be limited to the illustrated orientations. Those skilled in the art will appreciate that other orientations of various components described herein are possible.

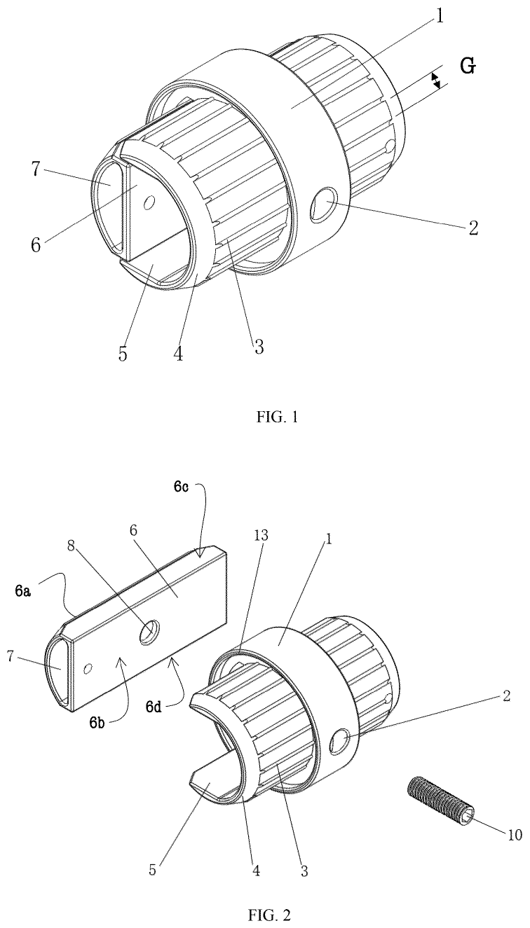

FIGS. 1 and 2 illustrate an embodiment of a tubing connector. The tubing connector can be an assembly including a connecting block 4 and a slider 6. The slider 6 can be sized to slide relative to the connecting block 4 with tight fitting, sliding surfaces. As such, the connecting block 4 can be considered a main portion and the slider 6 can be considered as secondary portion that moves relative to the main portion.

The connecting block 4 includes a main portion that is generally defined by a cylindrical shape with concentric portions that create an external diameter, internal diameter and a wall thickness. More specifically, the shape of the main portion of the connecting block 4 resembles that of the letter C. The external diameter of the circular C-shape is centrally located about the major axis of the cylindrical shape and may be sized based on the internal diameter of the tubing that is being connected together. The internal diameter of the C-shape can be based on the minimum wall thickness for the forces required to keep the tubing sections together. The opening width in the C-shape can be based on the friction forces required by the slider 6 to keep the two tubing sections together when the tubing is loaded. The length of the connecting block 4 may vary based on the amount of tubing remaining prior to a bend in the tube or the friction forces needed to keep the tubing sections together under load. The connecting block 4 can have a chamfer at each end configured to allow for simplified installation into the tubing.

The connecting block 4 can include support strips 3. The support strips 3 generally protrude radially from the connecting block 4. The support strips 3 may have a gap G separating them into segments. The gap G between the segments may be a consistent length or it may vary. The shape of the gap G between the segments may also be consistent or be variable. The height of the support strip 3 can be based on the internal diameter of the tube as well as the external diameter of the connecting block 4. The length and shape of the gap G can be based on the needs of the design.

The connecting block 4 can include a cover portion 1 which can be in the form of an annular ring. The cover 1 can be an annular portion extending from the outer surface of the connecting block 4. The cover 1 can be generally located centrally along the major axis of the connecting block 4. The external surface of the cover 1 can be consistent or uniform around the entire diameter.

Disclosed above, the connecting block 4 can have a C-shaped profile. Where the cover 1 and the connecting block 4 overlap, they can be attached to form a single part. Optionally, the connecting block 4 and cover 1 can be formed as a single, monolithic piece. In an area where they do not overlap, the internal surface can include a boss 12. The boss 12 can have a rectangular shape extending inward from the cover 1. The internal diameter of the boss 12 can be smaller than the diameter of the support strips 3. The width of the boss 12 can be smaller than the width of the cover 1.

The cover 1 includes a fixing hole 2. The fixing hole 2 can be a radial hole that goes through both the cover 1 and connecting block 4 where they overlap and are connected or formed as a solid piece. The fixing hole 2 is circular in shape and is sized to receive a screw 10.

The cover 1 can include sealing rings 13. The sealing rings 13 can be a pair of surfaces offset axially inwardly from the external surfaces of the cover 1 which are perpendicular to the major axis. The offset surface can be configured to provide a hard stop for tubing sections to contact during installation. For example, the sealing rings 13 can be positioned such that when the tubing sections contact the sealing rings 13, the tubing ends are covered by the outer diameter of the cover 1 which can provide an aesthetically pleasing connection. Covering the tubing sections may also prevent the sharp edges from creating a potential hazard to the user or catching on items like clothing. In such a configuration, two channels facing in opposite directions are formed by the cover 1 and the outer surface of the connecting block 4.

The connecting block 4 can have an internal void that extends over the entire axial length. The void may have a shape which resembles the letter U. The void is open similar to the letter U except where the cover 1 is located. The void can be constructed from the internal surface of the connecting block 4 and the surfaces of the installation guides 5. The internal surface of the connecting block 4 can be based on wall thickness configured to support the intended functions and/or manufacturing parameters. The installation guides 5 can be a pair of surfaces that are parallel to each other as well as being parallel to the fixing hole 2. The surfaces of the installation guides 5 can be flat and equal distance from the fixing hole 2. The surfaces of the installation guides 5 intersect with the cylindrical internal diameter of the connecting block 4. Optionally, the surfaces of the installation guides 5 may not be offset symmetrically from the fixing hole 2 and still provide the desired functionality.

The connecting block 4 can be made of many different materials which would satisfy the intended function of the connection. The material selection can be based on the manufacturing processes that yield high volume parts, such as but not limited to, casting or injection molding. Those materials can be varying grades of metal and or various plastic. The plastics may be filled with fibers for additional desired properties.

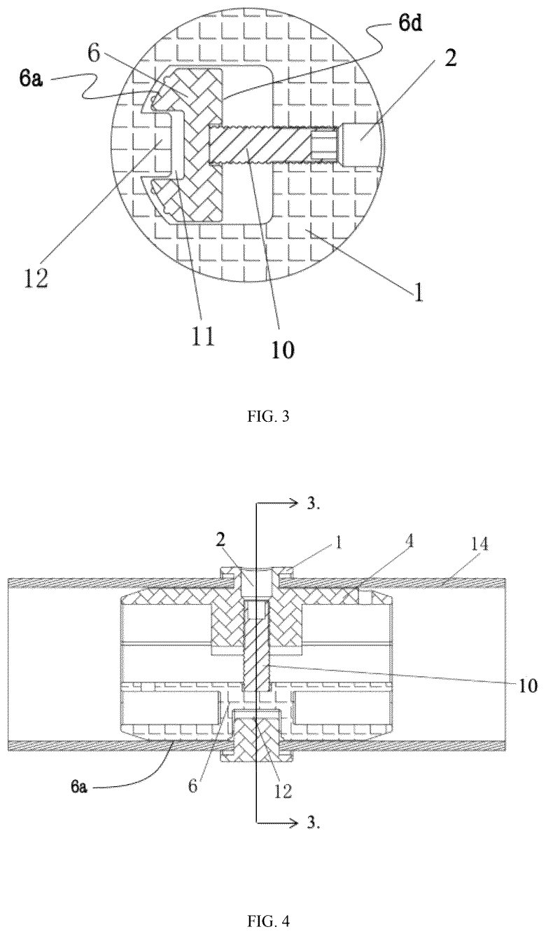

FIG. 2 and FIG. 3 further illustrate an embodiment of the slider 6. The external shape of the slider 6 has four sides. The largest side of the slider 6 has an external circular profile 6a when viewed axially and can run the entire length of the slider 6. The diameter of the external circular profile can be the same as, close to, substantially the same as or correspond to the diameter of the external surface of the connecting block 4.

The slider 6 includes a flat surface 6b which is located opposite the largest side of the slider 6 and can run the entire, axial length. While the surface 6b is illustrated as flat, the surface 6b may be any shape.

Perpendicular to the flat surface 6b is a pair of parallel surfaces 6c, 6d which create the final two surfaces of the slider 6. The parallel surfaces 6c, 6d of the slider 6 derive their spacing from being complimentary to the installation guides 5 of the connecting block 4. Additionally, the flat surface 6b opposite the cylindrical surface 6a of the slider 6 includes the limit slot 8. The limit slot 8 is a circular cavity with a diameter greater than the screw 10. The location of the limit slot 8 is based on the location of the fixing hole 2 of the connecting block 4.

The slider 6 includes an arc-shaped cavity 7. The shape of the arc-shaped cavity 7 can be based on the minimum wall thickness needed for the tubing connection to function or to be manufactured. This arc-shaped cavity 7 can run the axial length of the slider 6.

The slider 6 may be made of many different materials which can support the intended function of the connection. The material selection can be based on the manufacturing processes that yield high volume parts, such as but not limited to, casting or injection molding. Those materials may be varying grades of metal and or various plastic. The plastics may be filled with fibers for additional desired properties.

FIG. 2 and FIG. 3 illustrate an embodiment of the screw 10 which is included in the connecting block 4. The screw 10 includes a main portion that is generally defined by a cylindrical shape. Optionally, a spring (not shown) can be provided axially along the outside of the screw 10 and may have a triangularly shaped profile in a helical pattern. Other types of springs can be used. The profile of the fixing hole 2 of the connecting block 4 can be based on the size of the screw 10. The largest diameter of the fixing hole 2 is greater than the diameter of the screw 10. As the profile continues inward towards the tubing central axis, the profile of the fixing hole 2 assumes that of the screw 10 in order to create a helical interface between the fixing hole 2 and the screw 10.

The screw 10 may be made of many different materials which can support the intended function. The material selection can be based on commercially available options to limit costing tooling expenses. Those materials can be of varying grades of metal and or various plastic. The plastics may be filled with fibers for additional desired properties.

FIG. 3 and FIG. 4 illustrate an embodiment of a boss slot 11 which is integrated into the slider 6. The boss slot 11 is a rectangularly shaped slot located in the cylindrical, external surface of the slider 6. The dimensions of the boss slot 11 can be based on the shape of the boss 12 located on the cover 1.

FIG. 3 and FIG. 4 further illustrate an embodiment of the assembly of the tubing connector. The slider 6 is slid along the central axis of the connecting block 4. The height of the slider 6, from the circular, external surface 6a to the flat surface 6b opposite the circular surface 6a, can be smaller than the distance between the internal diameter of the boss 12 and the opposite internal surface of the connecting block 4 to ensure that the slider 6 can be conveniently assembled within the connecting block 4. To engage the connecting block 4, the boss slot 11 of the slider 6 fits onto the boss 12 of the cover 1. To secure the slider 6 to the connecting block 4, the screw 10 is inserted through the fixing hole 2 and screwed into place. The screw 10 interfaces with the slider 6 by engaging the slot limit 8.

To connect the circular tubes 14, each end of the circular tubes 14 are slid over the corresponding support strips 3 and forced against the sealing rings 13, respectively. The screw 10 is screwed inward towards the slider 6. The screw 10 forces the slider 6 against the internal diameter of the circular tubing 14. As such, the screw 10 can be considered as an adjustment member that moves the slider 6.

The circular tubing 14 is loaded radially, from the internal diameter, by the connecting block 4 and the slider 6. The force produced by the contact of the connecting block 4 and the slider 6 against the circular tubing 14 creates friction which holds the tubing sections together. The internal diameter of the circular tube 14 sections can be similar to create the friction desired for the connection. The external diameter of the circular tube 14 sections can differ, optionally the external diameter of the circular tube sections 14 are both sized to make sufficient contact with the respective sealing rings 13 and be covered by the cover 1.

What is claimed is:

1. A tubing connector for connecting first and second separate tubing sections having a cylindrical shape, the tubing connection comprising:
a main portion, comprising:
a C-shaped profile portion which extends a length of the main portion, the C-shaped profile portion including a C-shaped outer surface portion configured to be pressed against inner surfaces of the first and second separate tubing sections;
an annular ring portion centrally located along a length of the main portion, the annular ring portion positioned outwardly of the outer surface portion;
first and second channels defined between the outer surface portion and the annular ring portion, the first and second channels facing in opposite directions and configured to receive ends of the first and second separate tubing sections, respectively; and
a guide portion including main guide surfaces which extend along the length of the main portion, wherein the guide surfaces are parallel;
a threaded hole extending through the C-shaped profile portion and the annular ring portion; and
a secondary portion configured to be slidable relative to the main portion, the secondary portion comprising:
first and second secondary guide surfaces configured to slide along the main guide surfaces;
an outer curved surface configured to be pressed against the inner surfaces of the first and second separate tubing sections; and
an adjustment member configured to move the secondary portion in a radially outward direction relative to the main portion, so as to press the outer curved surface of the secondary portion against the inner surfaces of the first and second separate tubing sections, in use, wherein the adjustment member comprises a threaded outer profile configured to threadedly engage the threaded hole.

2. The tubing connector of claim 1, wherein the secondary portion is configured to reside within an overall cylindrical shape of the main portion.

3. The tubing connector of claim 1, wherein the annular ring is configured to cover the ends of the separate tubing sections.

4. The tubing connector of claim 1, wherein movement of the threaded member causes the secondary portion to translate linearly and wherein the movement of the threaded member causes the main portion and secondary portion to contact an internal diameter of the separate tubing sections.

5. A tubing connector for connecting first and second tube ends having a cylindrical shape, the tubing connection comprising:
a main portion, comprising:
a C-shaped profile portion which extends a length of the main portion, the C-shaped profile portion including a C-shaped outer surface portion configured to be pressed against inner surfaces of the first and second tube ends;
an annular cover portion positioned outwardly of the outer surface portion;
first and second channels defined between the outer surface portion and the annular cover portion; and
a guide portion including main guide surfaces which extend along the length of the main portion, wherein the guide surfaces are parallel;
a secondary portion configured to be slidable relative to the main portion, the secondary portion comprising:
first and second secondary guide surfaces configured to slide along the main guide surfaces;
an outer curved surface configured to be pressed against the inner surfaces of the first and second tube ends; and
an adjustment member configured to move the secondary portion in a radially outward direction relative to the main portion, so as to press the outer curved surface of the secondary portion against the inner surfaces of the first and second tube ends, in use.

6. The tubing connector of claim 5, wherein the secondary portion is configured to reside within an overall cylindrical shape of the main portion.

7. The tubing connector of claim 5, wherein the annular cover portion is configured to cover the ends of the first and second tube ends.

8. The tubing connector of claim 5, wherein the annular cover portion is centrally located along the length of the main portion.

9. The tubing connector of claim 5, wherein the first and second channels face in opposite directions and are configured to receive ends of the first and second tube ends, respectively.

10. The tubing connector of claim 5, additionally comprising a threaded hole extending through the C-shaped profile portion and the annular cover portion, wherein the adjustment member comprises a threaded outer profile configured to threadedly engage the threaded hole.

11. The tubing connector of claim 10, wherein movement of the adjustment member causes the secondary portion to translate linearly and wherein the movement of the adjustment member causes the main portion and secondary portion to contact an internal diameter of the first and second tube ends.

12. A tubing connector for connecting first and second tube ends, the tubing connection comprising:
a main portion, comprising:
an outer surface portion configured to be pressed against inner surfaces of the first and second tube ends;
an annular cover portion positioned outwardly of the outer surface portion;
a guide portion including main guide surfaces;
a secondary portion configured to be slidable relative to the main portion, the secondary portion comprising:
first and second secondary guide surfaces configured to slide along the main guide surfaces;
an outer surface configured to be pressed against the inner surfaces of the first and second tube ends; and
an adjustment member configured to move the secondary portion in an outward direction relative to the main portion, so as to press the outer surface of the secondary portion against the inner surfaces of the first and second tube ends, in use.

13. The tubing connector of claim 12, wherein the tubing connector is configured for connecting tubes ends that have a cylindrical shape, wherein the outer surface portion comprises a C-shaped profile, and wherein first and second channels are defined between the outer surface portion and the annular cover portion.

14. The tubing connector of claim 12, wherein the secondary portion is configured to reside within an overall cylindrical shape of the main portion.

15. The tubing connector of claim 12, wherein the annular cover portion is configured to cover the first and second tube ends.

16. The tubing connector of claim 12, wherein the annular cover portion is centrally located along a length of the main portion.

17. The tubing connector of claim 13, wherein the first and second channels face in opposite directions and are configured to receive ends of the first and second tube ends, respectively.

18. The tubing connector of claim 12, additionally comprising a threaded hole extending through the main portion and the annular cover portion, wherein the adjustment member comprises a threaded outer profile configured to threadedly engage the threaded hole.

19. The tubing connector of claim 18, wherein movement of the adjustment member causes the secondary portion to translate linearly and wherein the movement of the adjustment member causes the main portion and secondary portion to contact an internal diameter of the first and second tube ends.
